(19) United States
(12) Patent Application Publication
(10) Pub. No.: US 2007/0042146 A1
(43) Pub. Date: Feb. 22, 2007

(54) Grease-resistant bag and related methods

(75) Inventor: Stuart Sharp, Greer, SC (US)

Correspondence Address: STOEL RIVES LLP - SLC, 201 SOUTH MAIN STREET, ONE UTAH CENTER, SALT LAKE CITY, UT, 84111, US

(73) Assignee: Exopack-Technology, LLC, Spartanburg, SC (US)

(21) Appl. No.: 11/240,944

(22) Filed: Sep. 30, 2005

Related U.S. Application Data
(60) Provisional application No. 60/709,512, filed on Aug. 19, 2005.

(51) Int. Cl. B32B 27/32; B32B 27/08

(52) U.S. Cl. 428/35.2; 428/35.7

(57) ABSTRACT

An embodiment of a bag includes a bag body having pair of opposing bag ends and an inner face of an outer ply abuttingly adhered to an outer face of an inner ply. The bag can include the outer ply having an inner face of a grease-resistant film abuttingly adhered to an outer face of a paper layer. The bag can further include the inner ply having a multi-layer film having a grease-resistant material positioned between a pair of heat-sealable films adapted to advantageously melt and closingly seal at least one of the bag ends responsive to heat being applied thereto. Embodiments of methods of assembly, positioning, using, and constructing a bag are also provided.

### BACKGROUND OF THE INVENTION

1. Field of the Invention

The present invention relates generally to the bags or packaging industry, and more particularly, to grease-resistant and heat-sealable bags and related methods.

2. Description of the Related Art

Consumer packaging is important in today's marketplace. Not only do the products within the packaging have to be fresh, but the outside portions of the packaging must be aesthetically appealing. Traditionally, the focus has been to either sacrifice external appearance for internal protection, or sacrifice internal protection for external appearance, but seldom are the concerns with both external appearance and internal protection addressed with a single bag.

Most consumer packaging is made from single ply substrates that are added together to form multi-ply or multi-wall flexible packaging of a single or solitary type of material. Prior food bags, particularly prior pet food bags, have generally been manufactured to be either a substantially plastic structure or a substantially paper structure. When paper bags are utilized, the bag strength often is derived solely from the paper, and the bags are generally pinch-bottom styles. Problems exist with these bags with regard to the ability to offer additional features such as easy open/close structures, handles, and other advantageous features. Problems also exist with regard to insect infestation from penetration inside some pinch-bottom bags. Therefore, a desire exists in the art for a bag that improves upon the pinch-bottom variety, to solve the problem of insect infestation, among other problems.

Furthermore, foods such as pet foods are exhibiting an increased grease or fat component. The grease component of these foods in the past tended to penetrate the layers of the bag or gradually led to deterioration of the bag over time. The increasing grease content has created a desire in the art for a food bag with grease resistant properties.

### SUMMARY OF THE INVENTION

In view of the foregoing, embodiments of the present invention advantageously provide an enhanced bag that is heat-sealable and which prevents grease from penetrating therethrough. Embodiments of the present invention also advantageously provide a method for constructing a bag that is heat-sealable and which prevents grease from penetrating therethrough. Embodiments of the present invention further advantageously include a bag body and a pair of bag ends adapted to meltingly close and seal the bag ends to thereby retain a food element, as well as any grease component associated with the food element, within the inner confines of the bag body. Embodiments of the invention allow the bag to carry over twenty-five pounds of pet food with relative ease.

For example, an embodiment of the present invention advantageously provides a food bag to carry a food element having a grease component so that grease from the grease component is advantageously prevented from penetrating from within the bag to outside the bag. Additionally, for example, grease from other grease components not associated with the bag is advantageously prevented from penetrating from outside the bag to within the bag. An embodiment of the food bag, for example, can include a tubular bag body having pair of opposing open bag ends and an inner face of an outer ply abuttingly adhering to an outer face of an inner ply. The outer ply includes an inner face of a grease-resistant polyester film abuttingly adhered to an outer face of a paper layer with a tie layer that can include a solventless adhesive. For example, the paper layer can advantageously have a greater bending stiffness than the polyester film. Also, for example, the paper layer can advantageously have a greater thickness than the polyester film. The bag can also include the inner face of the polyester film having printed indicia thereon to advantageously enhance visual appearance of the bag, and the polyester film can be adapted to allow an amount of light to advantageously transmit therethrough to thereby allow viewing of the printed indicia from outside of the bag.

An embodiment of the food bag, for example, can further include the inner ply including an inner face of a first heat-sealable film abuttingly adhered to an outer face of a grease-resistant material and an inner face of the grease-resistant material abuttingly adhered to an outer face of a second heat-sealable film. The bag can further include a portion of the second heat-sealable film overlying a portion of the polyester film to define an overlapping seam of the tubular bag body extending along a longitudinal extent of the bag. The outer ply has a substantially similar longitudinal length from one bag end to the other bag end along a circumferential periphery of each of the opposing bag ends, and the inner ply has a substantially similar longitudinal length from one bag end to the other bag end along a circumferential periphery of each of the opposing bag ends.

An embodiment of the food bag, for example, can further include the pair of bag ends adapted to be positioned so that opposingly facing first and second portions of the inner ply are compressed between opposingly facing first and second portions of the outer ply to advantageously define a compressed lip. The compressed lip, for example, has first portion of the second heat-sealable film of the inner ply meltingly bonded with an opposingly facing second portion of the second heat-sealable film of the inner ply along the transverse extent of at least one of the pair of bag ends responsive to heat applied thereto to thereby advantageously closingly seal the at least one of the pair of bag ends so that the food element when positioned therein is advantageously retained within inner confines of the bag defined by other unsealed portions of the second heat-sealable film positioned between the opposing pair of bag ends.

Another embodiment of a bag of the present invention also advantageously can include a bag body having pair of opposing bag ends and an inner face of an outer ply abuttingly adhered to an outer face of an inner ply. The bag, for example, can include the outer ply having an inner face of a grease-resistant film abuttingly adhered to an outer face of a paper layer. The bag can further include the inner ply having a multi-layer film having a grease-resistant material positioned between a pair of heat-sealable films adapted to advantageously melt and closingly seal at least one of the bag ends responsive to heat being applied thereto.

Another embodiment of the present invention also advantageously provides a method or process for constructing a bag. An embodiment of the method can include, for example, adhering an inner face of a grease-resistant film with an outer face of a paper layer to create an outer ply, adhering a grease-resistant material between a pair of heat-sealable films to create a multi-layer inner ply, adhering an inner face of the outer ply to an outer face of the inner ply to create a laminate with a pair of opposing ends, and overlying a portion of an inner face of the inner ply located at one lateral side of the laminate onto a portion of an outer face of the outer ply located at another lateral side of the laminate to define an overlapping seam extending along a longitudinal extent of a tubular portion of the bag.

Another embodiment of a method of the present invention, for example, can further include melting opposing faces of at least one of the pair of heat-sealable films together along a transverse extent of at least one of the pair of ends responsive to heat being applied thereto, and closingly sealing at least one of the pair of ends responsive to the melting without overlapping any portion thereof so that a grease element when positioned therein is advantageously retained between other portions of the inner ply remaining unmelted and unsealed and to thereby advantageously prevent grease from penetrating from within the bag to outside the bag and advantageously prevent grease from penetrating from outside the bag to within the bag.

Embodiments of the present invention advantageously combine the use of polymeric structures and paper, thereby combining the advantages of the thickness and bending stiffness of paper with the puncture-resistant and grease-resistant properties of polyester, including the heat-sealable characteristics of films, such as, for example, heat-sealable polyethylene and oriented polypropylene. Embodiments of the present invention also provide increased barrier protections from grease, endurance, strength, physical integrity, thickness, stiffness, resistance to stretching from pressure from food elements within the bag, and heat-sealable characteristics not offered with other bags. The bag advantageously prevents problems customarily associated with greasy products such as pet food, for example, and eliminates the absorption and penetrable effect of the grease component included in such foods as pet food. Various bags are often used in other settings where greasy elements are contained within the bags, and the present invention advantageously contributes to solving such problematic concerns attributable to the grease. Other applications of the bag may include dry foods, beverages, feed, soil, lawn and garden, building materials, and other markets to advantageously prevent grease from penetrating from outside the bag to within the bag and to prevent grease from penetrating from within the bag to outside the bag.

Embodiments of the present invention offer the further advantage of heat-sealing the bag ends instead of sealing the bag ends, for example, as a pinch-bottom structure. The heat-seal offers many advantages over the pinch-bottom structure, including a more secure seal, a tighter bond, a more sound structure, and a more attractive appearance to consumers. The heat-seal advantageously offers more efficient and economical means of manufacturing the bag. Further, insect infestation has been a substantial problem associated with pinch-bottom style bags. The heat-seal closure of the bag ends solves the problem of insect infestation which has been so prevalent with the pinch-bottom variety of bags.

Embodiments of the bags manufactured in this way using the described construction and materials also offers the advantage of allowing the bag to be made containing consumer features such as easy-carry handles, reclosable zippers, and easy-to-open features, and cost-effective measures not currently available in the trade with such bags as pinch-bottom style bags.

### BRIEF DESCRIPTION OF THE DRAWINGS

Some of the features, advantages, and benefits of the present invention having been stated, others will become apparent as the description proceeds when taken in conjunction with the accompanying drawings, in which:

FIG. 1A is a perspective view of a bag according to an embodiment of the present invention having pet food therein;

FIG. 1B is a side elevational view of a bag according to an embodiment of the present invention;

FIG. 2 is a perspective view of an outer ply of a bag having a grease-resistant film and a paper layer according to an embodiment of the present invention;

FIG. 2A is a perspective view of an outer ply of a bag having a grease-resistant film, a paper layer, and an outer coating according to an embodiment of the present invention;

FIG. 2B is a perspective view of an outer ply of a bag having a grease-resistant film with a printed indicia thereon and a paper layer according to an embodiment of the present invention;

FIG. 3 is a sectional view along line 3-3 of FIG. 2 of the outer ply of a bag according to an embodiment of the present invention;

FIG. 3A is a sectional view along line 3A-3A of FIG. 2A of the outer ply of a bag having an outer coating according to an embodiment of the present invention;

FIG. 4 is a perspective view of an inner ply of a bag having a grease-resistant film adhered between a pair of heat-sealable films according to an embodiment of the present invention;

FIG. 5 is a sectional view along line 5-5 of FIG. 4 of the inner ply of a bag according to an embodiment of the present invention;

FIG. 6 is a perspective view of the outer ply of a bag adhering to the inner ply according to an embodiment of the present invention;

FIG. 7 is a sectional view along line 7-7 of FIG. 6 of the outer and inner plies of a bag according to an embodiment of the present invention;

FIG. 8 is a perspective view of the inner and outer plies of a bag illustrated to fold and overlap to create a tubular shape of the bag;

FIG. 9 is a perspective view of a tubular shape of a bag with two open bag ends and a longitudinal seam thereupon according to an embodiment of the present invention;

FIG. 10 is a perspective view of a bag with one of the bag ends being melted and closingly sealed to form a lip according to an embodiment of the present invention;

FIG. 11 is a perspective view of a bag with one of the bag ends melted and closingly sealed to form a lip at the closed bag end according to an embodiment of the present invention;

FIG. 12 is an enlarged sectional view along line 12-12 of FIG. 11 illustrating the layers of a closed bag end according to an embodiment of the present invention;

FIG. 13 is a perspective view of a bag with a closed end and an open end receiving a number of food elements according to an embodiment of the present invention;

FIG. 14 is a perspective view showing the inner and outer ply of a bag preventing the penetration of grease therethrough according to an embodiment of the present invention;

FIG. 15 is a sectional view along line 15-15 of FIG. 14 illustrating the inner and outer plies of the bag preventing the penetration of grease therethrough according to an embodiment of the present invention;

FIG. 16 is a flow diagram illustrating a method for constructing a bag according to an embodiment of the present invention; and

FIG. 17 is a flow diagram illustrating a method for constructing a bag according to an embodiment of the present invention.

### DETAILED DESCRIPTION

The present invention will now be described more fully hereinafter with reference to the accompanying drawings, which illustrate embodiments of the invention. This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art. Like numbers refer to like elements throughout. The prime notation, if used, indicates similar elements in alternative embodiments.

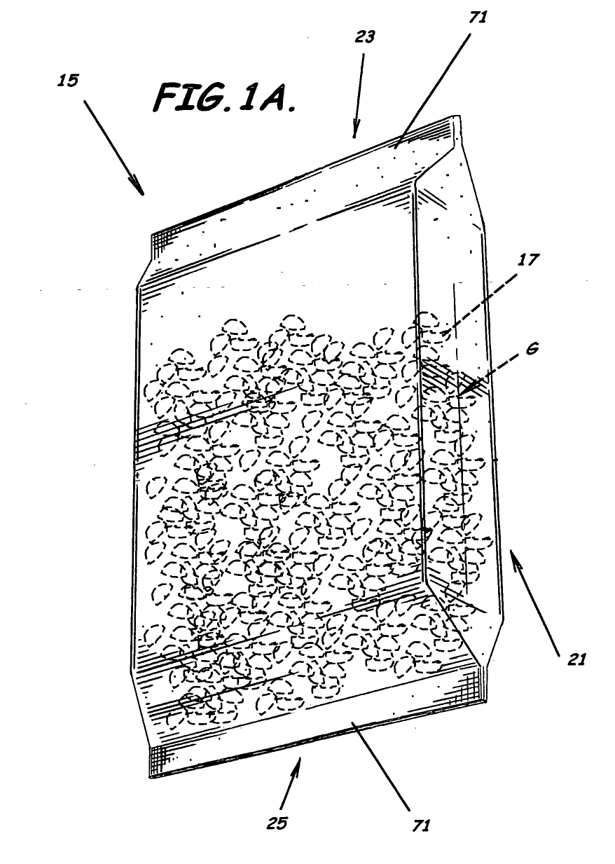

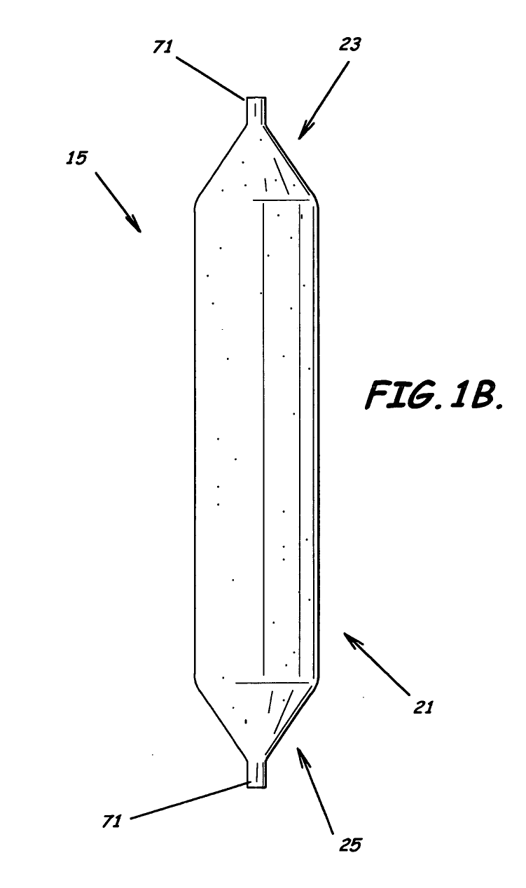

FIG. 1 shows a perspective view of an embodiment of a food bag 15 having contained therein a food element 17 with a grease component G. As shown in FIG. 1, for example, grease from the grease component G of the food element 17 is advantageously prevented from penetrating from within the bag 15 to outside the bag 15. Also, for example, grease from other grease components not associated with the bag is advantageously prevented from penetrating from outside the bag 15 to within the bag 15. Additionally, the bag 15 also can alternatively be utilized for carrying elements 19 other than food. For example, other elements 19 having components with similar characteristics to grease, as understood by those skilled in the art, can also be advantageously prevented from penetrating the walls or plies of the food bag 15.

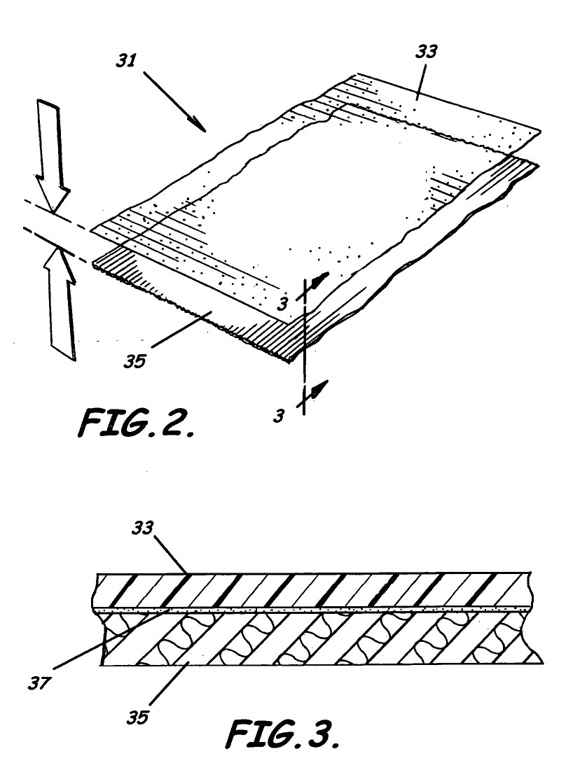

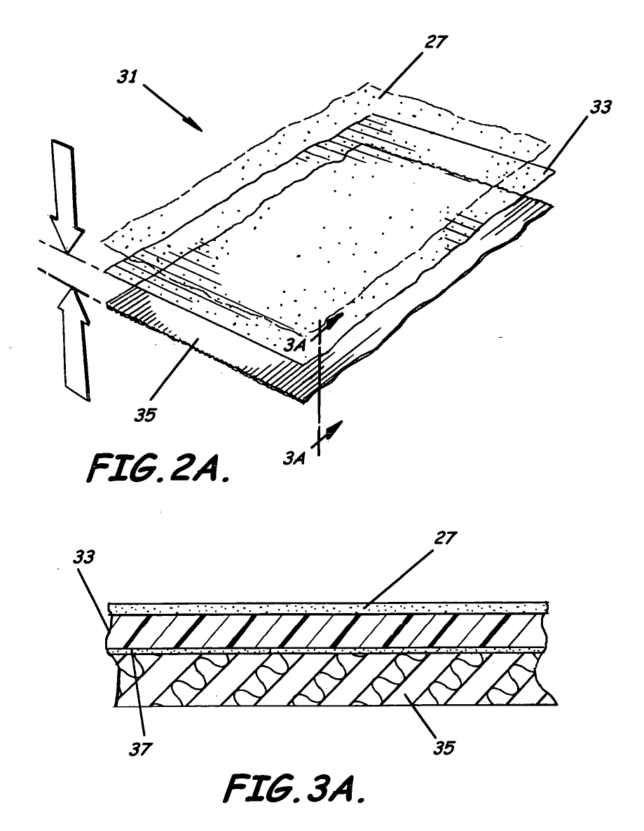

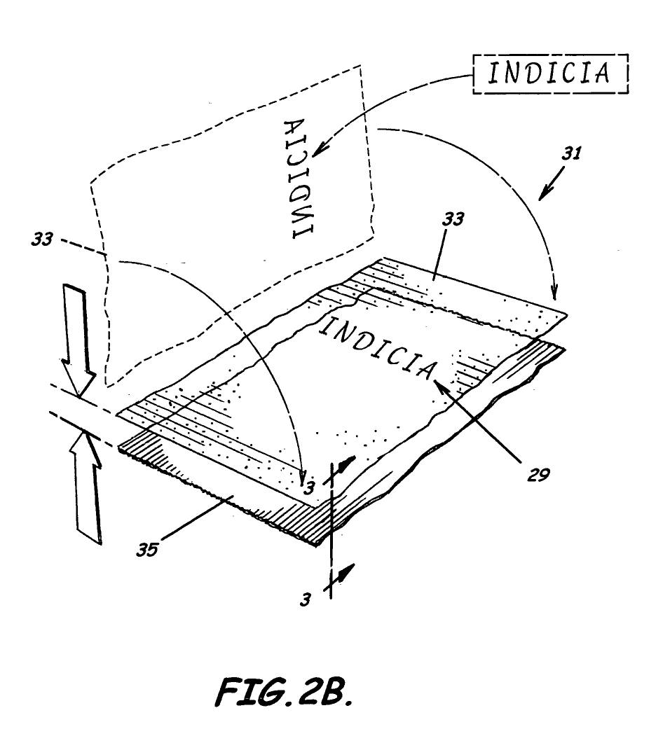

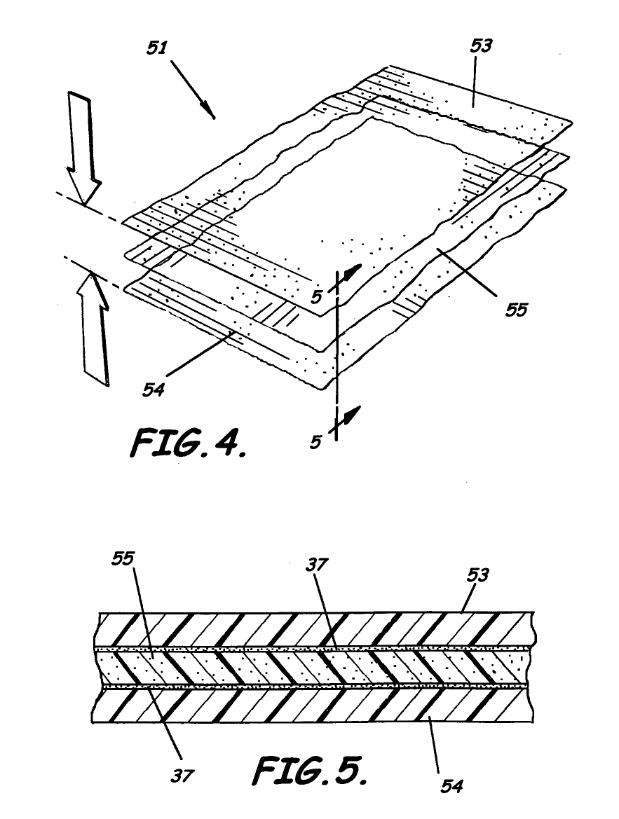

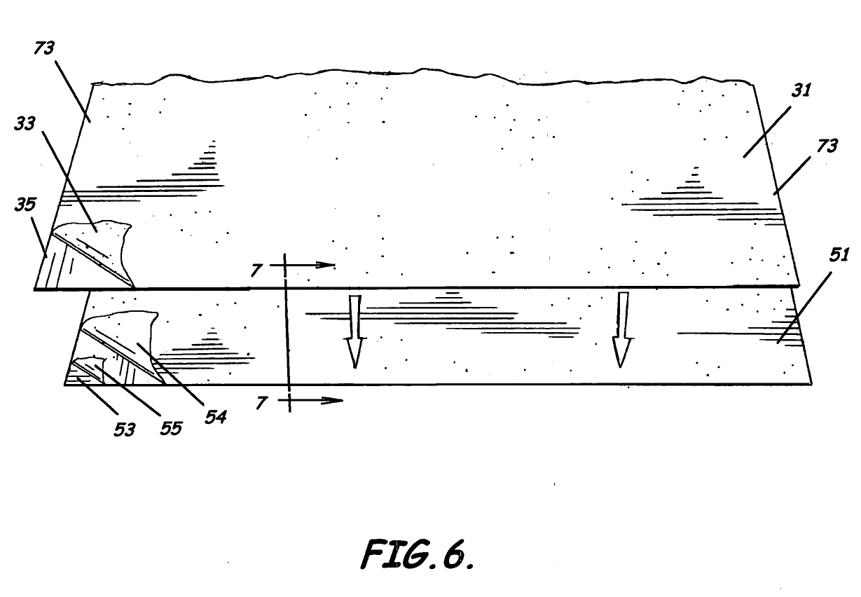

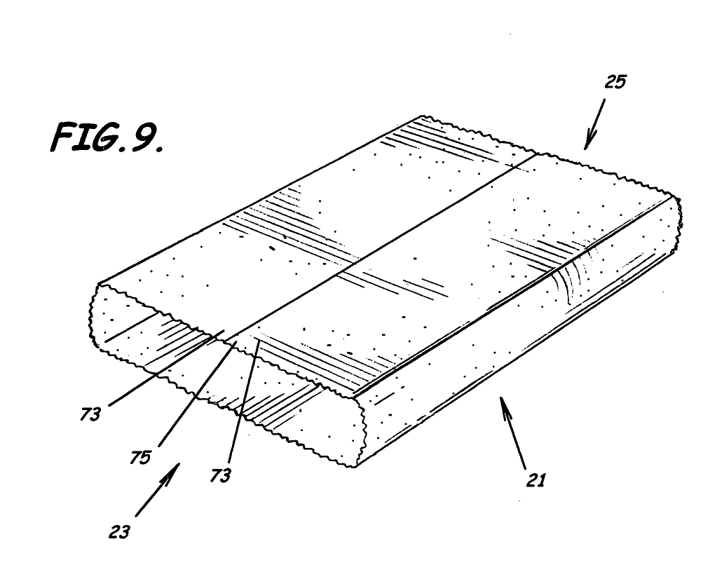

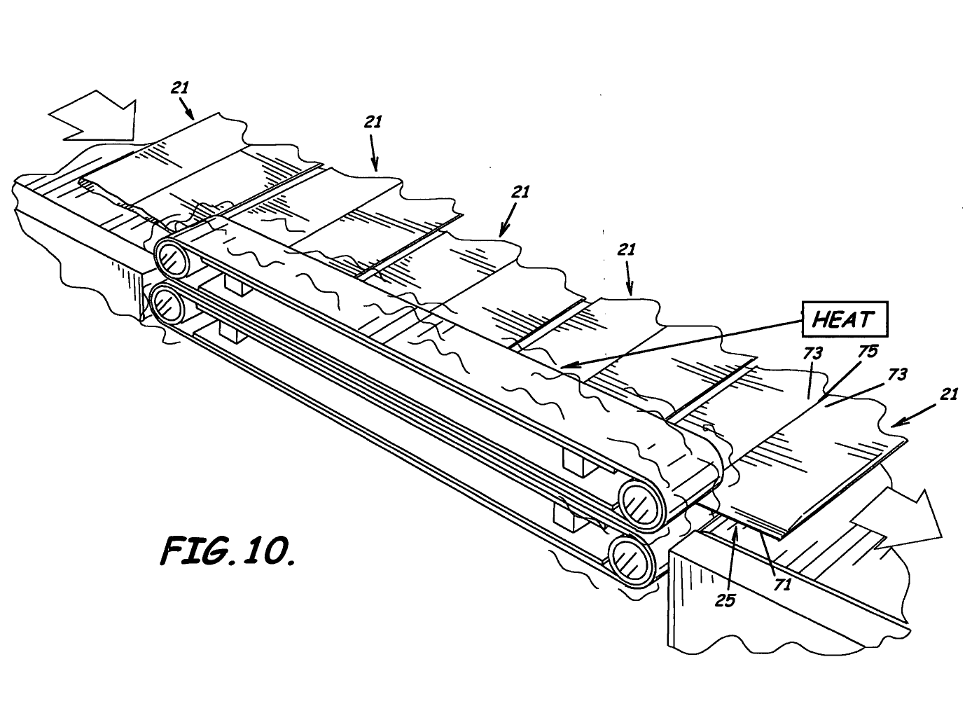

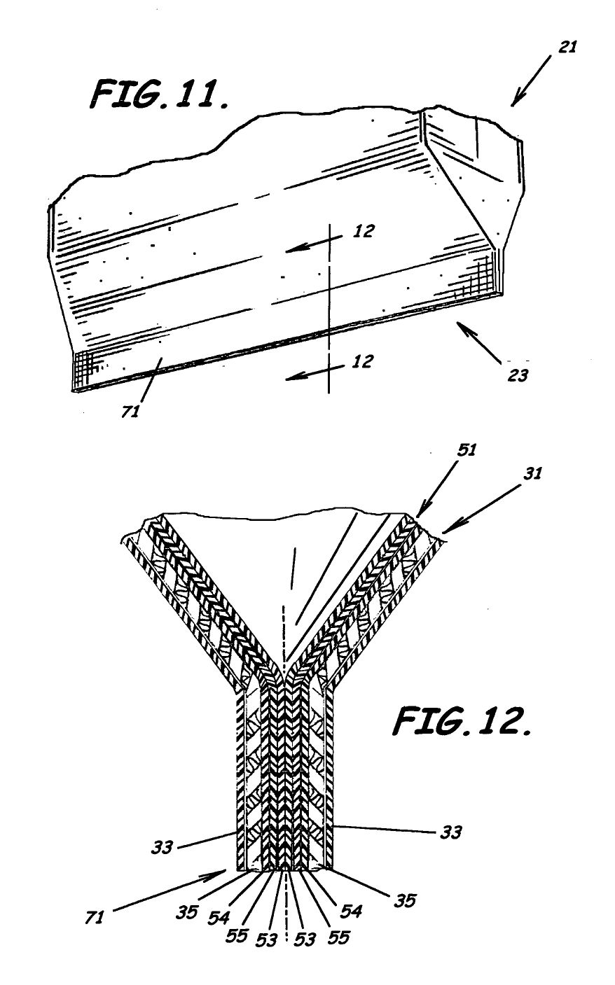

An embodiment of the bag 15 has an outer ply 31 and an inner ply 51, as shown for example in FIGS. 6-9, where an inner face of the outer ply 31 abuttingly adheres to an outer face of an inner ply 51. An embodiment of the outer ply 31, shown for example in FIGS. 2-3, includes an inner face of a grease-resistant film 33 abuttingly adhered to an outer face of a paper layer 35 with a tie layer 37, such as, for example, a solventless adhesive, a plastic-type bonding material, a coax film, or other suitable tie layer, as understood by those skilled in the art. The grease-resistant film 33 can include a polymeric material, for example, selected from the group consisting of: polyethylene terephthalate (PET), polyethylene terephthalate polyester (PETP), polytrimethylene terephthalate (PTT), polybutylene terephthalate (PBT). The PTT and PBT are generally utilized for similar purposes as the PET, but may perform slightly better than the PET to varying degrees. The PTT and PBT, however, for example, may be slightly more expensive than the PET to varying degrees. Polyester films 33 such as the aforementioned are advantageously hard, strong, ductile, stiff, strong, dimensionally stable, puncture-resistant, grease-resistant, resistant to absorption, and have excellent barrier properties and chemical/mechanical properties as understood by those skilled in the art. Additionally, for example, the grease-resistant film 33 can also include other materias containing grease-resistant properties, as understood by those skilled in the art, such as resistance to mineral oils, solvents, and acids. For example, other materials that have generally similar properties as the aforementioned polyester films 33 can be, for example, plastics, polyvinyl chloride (PVC), polyamide (PA), polyethylene (PE), polystyrene (PS), and polypropylene (PP), as understood by those skilled in the art. The grease-resistant film 33, for example, can be in the range of about 36 gauge to about 300 gauge and, for example, can be about 48 gauge for some applications such as pet food bags. The film 33, however, can have other gauges for pet food bags and other applications as desired, as understood by those skilled in the art.

In one embodiment, the polyester film 33 can advantageously be treated with a coating 27 on the outer face of the outer ply 31 to advantageously provide enhanced barrier protection from grease penetrating from outside the bag 15 to within the bag 15, protecting against abrasion and moisture, and providing an attractive gloss finish. The coatings 27 can also include printed indicia 29 thereupon. The coatings 27 can include, for example, flexography coatings 27, proprietary coatings 27, or other suitable coatings 27. In the preferred embodiment, the coatings 27 can utilize Repellence™ barrier coatings or Aqua Crystal™ film coatings, both of which are manufactured by Exopack, LLC of Spartanburg, S.C., as understood by those skilled in the art. The coatings can facilitate adhesion and bonding and can enhance the coefficient of friction of the bag.

The coating 27 provided on the outer face of the polyester film 33 of the outer ply 31 provides oil, grease, and water resistance without the use of inferior traditional films and/or foils. The coatings 27 effectively preserve the quality of the package contents as well as the physical integrity of the bag 15 as a whole. The Repellence™ coating 27, for example, is particularly advantageous for products that contain oil or grease and to bags 18 that may occasionally be subjected to rain or other elements 19. The Aqua Crystal™ film coating 27, for example, is advantageous in part because of its clarity and gloss thereby enhancing the appearance to consumers.

In one embodiment, the outer face of the polyester film 33, for example, can have a coefficient of friction in a range of about 0.5 to about 0.9, as understood by those skilled in the art, but can alternatively feature differing ranges of coefficients of friction depending on the specific type of polyester film 33 employed in each instance and/or other applications. The coefficient of friction, for example, in a pet food bag application can advantageously be high enough so that the finished product does not have the tendency to slip or slide when positioned on a shelf or cabinet. An embodiment of the polyester film 33 may have a thickness varying from 36 gauge to 48 gauge, for example, but alternatively may have thicknesses above or below that range.

In one embodiment, the inner face of the grease-resistant film 33 of the outer ply 31 can advantagously include printed indicia 29 thereupon to enhance visual appearance of the bag 15. The polyester film 33 is adapted to allow an amount of light to transmit therethrough, as understood by those skilled in the art, to thereby allow viewing of the printed indicia 29 from outside of the bag 15. The polyester film 33 can be an amorphous classification which is highly transparent and colorless, or can alternatively be a semi-crystalline classification which is translucent or opaque with an off-white coloring. Amorphous polyester films 33 generally have better ductility than semi-crystalline polyesters, but less hardness and stiffness than the semi-crystalline type. The polyester film 33, for example, can be printed with solvent-based inks or water based inks, and can be printed overall with a flood coat of white ink, which may advantageously allow for better graphics. The embodiment featuring the flood coat of white ink may also advantageously impart the ability to mask grease if it somehow penetrated through a cut or crack in the polyester film 33. Also, for example, portions of the polyester film 33 can be treated with an acrylic chemical suitable for adhering to solvent based inks, water based inks, or other inks. In alternative embodiments, instead of reverse printing printed indicia 29 on the inner face of the polyester film 33, printed indicia 29 can be surface printed on the outer face of the polyester film 33, or otherwise can be left clear without any printed indicia 29 featured thereupon.

Embodiments of the invention can feature the paper layer 35 of the outer ply 31, for example, advantageously having a greater bending stiffness, modulus, and/or tensile strength than the polyester film 33 of the outer ply 31. Also, for example, embodiments of the invention can feature the paper layer 35 of the outer ply 31 having a greater thickness than the polyester film 33 of the outer ply 31, which additionally contributes to enhanced bending stiffness, modulus, and/or tensile strength of the paper layer 35 and increased stabilization of the bag, as understood by those skilled in the art. The range of thickness for the paper layer 35 can be generally in the range of about 1.75 millimeters to about 10 millimeters. For example, the minimum thickness of one embodiment includes a paper thickness of about 1.9 millimeters, which is relatively flimsy compared to paper 35 with advantageously greater thickness. For example, embodiments of the invention can feature a paper layer 35 of the outer ply 31 having a thickness in the range of about 3.5 millimeters to about 4.5 millimeters. The range of thickness for the polyester film 33 of the outer ply 31 can be generally in the range of about 0.25 millimeters to about 0.75 millimeters. For example, embodiments of the invention can feature a polyester film 33 of the outer ply 31 of about 48 gauge and/or having a thickness in the range of about 0.475 millimeters to about 0.485 millimeters. As understood by those skilled in the art, an increased thickness of the paper layer 35 or the polyester film 33 can provide for increased bending stiffness and increased stabilization of the bag.

Stiffness, in this regard, is generally understood to be bending stiffness or tensile stiffness, although other suitable measurements of stiffness can also be utilized in accordance with the present invention, such as droop stiffness, folding endurance, or other alternative measurements. Bending stiffness, for example, is an expression of the rigidity of paper or paperboard and is a function of the cube of the caliper thickness. As understood by those skilled in the art, this property of bending stiffness is to some extent related to the modulus of elasticity of the product and its thickness. The bending stiffness of the paper layer generally increases as the thickness of the paper layer is increased, as understood by those skilled in the art.

There are several instruments in use in the industry that measure stiffness, and they all operate in such a manner to bend the product as a way of measuring stiffness. As understood by those skilled in the art, there are generally 2-point bending instruments and 4-point bending instruments. Solid fiber board and small fluted combined board (to be used in folding cartons) is typically measured with 2-point bending instruments. Commonly used instruments include Taber, Gurley, and L&W instruments to measure bending stiffness. In the United States, Taber Stiffness is the most common stiffness measurement, and Gurley Stiffness is also used quite often. L&W instruments are more common in European countries to measure stiffness. As such, in accordance with the present invention, Taber Stiffness and Gurley Stiffness are therefore two methods of measuring bending stiffness for the particular applications and thicknesses of the paper layer 35 and the polyester film 33 in the ordinary course, as understood by those skilled in the art.

With respect to the bending stiffness measurements, as understood by those skilled in the art, the TAPPI (Technical Association of the Pulp and Paper Industry) has industry standards for measuring stiffness that are utilized, acknowledged, and/or implemented in embodiments of the present invention. The Gurley Stiffness Value is measured using a Gurley Stiffness Testor, manufactured by W. and L. E. Gurley of Troy, N.Y. In essence, as understood by those skilled in the art, this instrument measures the externally applied moment required to produce a given deflection of a strip of material of specific dimensions fixed at one end and having a concentrated load applied to the other end. The results are obtained as “Gurley Stiffness” values in units of grams. There is a reasonable correlation between Gurley Stiffness and Taber Stiffness for paperboard grades, as understood by those skilled in the art. As referenced in TAPPI Test Method T-543, paragraph 4.1.5, the full range of Gurley values range from approximately 1.39 to 56,888 Gurley Stiffness units, which after using the proper conversion equation roughly corresponds to Taber values ranging from approximately 0 to 806.3 Taber Stiffness units, as understood by those skilled in the art.

The Tables 1-3 in FIGS. 18-20 show a variety of data relating to stiffness, puncture resistance, tear resistance, and tear initiation, as understood by those skilled in the art. An additional Table 4 is included in FIG. 21 showing the raw data utilized in the calculations of tables 1-3 of FIGS. 18-20. The data from Table 4 of FIG. 21 includes properties of various materials and multi-layer combinations of materials. The raw data of Table 4 of FIG. 21 was used in tests to demonstrate the relative advantages of the multi-layer combinations. As understood by those skilled in the art, there are many different grades and gauges for the PET, paper, and film. As such, the tests are not intended to be a broad universal assertion derived from substituting a single example of a material for all types of that material. Rather, the tests are intended to provide an anecdotal indicator that fairly and adequately represents a benchmark of the clear advantages of combining different materials into a multi-layer combination, including advantageously enhancing stiffness, puncture resistance, tear resistance, and tear initiation, among other measurements. The raw data used a variety of materials, and Table 4 of FIG. 21 illustrates a number of abbreviations used to identify each material.

For example, in Tables 1-4, particularly in the raw data included within Table 4 of FIG. 21, the abbreviations which are used to illustrate various types of materials, as understood by those skilled in the art, are described as follows: CSR4 (i.e., tradename CSR4) represents a type of fluorocarbon treated, clay coated, bleached sheet of paper; MWK represents a type of multi-wall Kraft (MWK) brown paper; Trial BL Non-CC represents type of fluorocarbon treated, bleached (BL) sheet of paper that is non-clay-coated (Non-CC); W-RPSE represents a type of Royal Performance semi-extensible (RPSE) white paper; Ad One (i.e., Advantage One) represents a type of substrate of a heavy extensible sheet of paper; 65# BL-MWK represents a bleached (BL) multi-wall Kraft (MWK) sheet of paper having a basis weight of 65 lbs; 48 gauge PET represents a PET layer of 48 gauge; and 2.5 mil. FT 2510 coextruded film represents a nylon coextruded core film having a 2.5 mil. gauge and a 2510 grade specification. Furthermore, in Tables 1-4 in FIGS. 18-20, the paper references correspond to the paper layer 35 of the outer ply 31. The PET references correspond to the outer layer 33 of the outer ply 31. The FT 2510 coextruded film references correspond to the multi-layer or mono-layer formation of the inner ply 51.

FIG. 18, for example, shows the percent increase in machine-direction tensile stiffness and cross-direction tensile stiffness, as understood by those skilled in the art, for the following comparisons: 48 gauge PET, CSR4 paper, and 2.5 mil. FT 2510 coextruded film v. PET; 48 gauge PET, CSR4 paper, and 2.5 mil. FT 2510 coextruded film v. 2.5 mil. FT 2510 coextruded film; 48 gauge PET, Advantage One paper, and 2.5 mil. FT 2510 coextruded film v. PET; and 48 gauge PET, Advantage One paper, and 2.5 mil. FT 2510 coextruded film v. 2.5 mil. FT 2510 coextruded film. In embodiments of the invention, for example, the PET film and the paper layer in combination can have a percentage increase in tensile stiffness at least 100% greater than the PET film alone. Preferably, the PET film and the paper layer in combination have a percentage increase in tensile stiffness at least 750% greater than the PET film alone.

FIG. 19, for example, shows the percent increase in dull-puncture and sharp-puncture, as understood by those skilled in the art. FIG. 20, for example, shows the percent increase in machine-direction tear resistance and cross-direction tear resistance, as understood by those skilled in the art. FIG. 20, for example, also shows the percent increase in machine-direction tear initiation and cross-direction tear initiation, as understood by those skilled in the art. Each of the tables in FIGS. 19-20 illustrate data relating to the following comparisons: 48 gauge PET v. paper; and 48 gauge PET and 2.5 mil. FT 2510 coextruded film v. paper.

In this manner, in some embodiments of the invention, the paper layer 35 advantageously enhances the appearance of the bag 15 as a whole, and also advantageously enhances durability and product handling by consumers. Various base-weights of paper can be utilized, for example, ranging from about 30 lbs.-force per square inch to about 50 lbs.-force per square inch, as understood by those skilled in the art. Embodiments of the paper layer 35, for example, also can be clay-coated and bleached, as understood by those skilled in the art, or alternatively can be manufactured without clay-coating and without bleach. Embodiments of the paper layer 35 can also be treated with a fluorocarbon chemical to improve grease-resistance, as understood by those skilled in the art, or alternatively can be manufactured without applying a fluorocarbon chemical treatment or with applying a non-fluorocarbon treatment in some applications, for example. Also, for example, portions of the outer face of the paper layer 35 by illustrate printed indicia 29 printed thereupon. Procedures for printing printed indicia 29 can include process printing, rotogravure printing, innovative flexographic printing, or other processes of printing as understood by those skilled in the art. The paper layer 35 can also be treated with a chemical to advantageously provide enhanced protection from grease penetrating through the paper layer 35 of the bag 15.

The technical requirements of the paper layer 35 may be reduced because the grease-resistant polyester and nylon layers solve the grease problem. Thus, it is no longer necessary to utilize grades of paper layers 35 that have some degree of grease-resistant properties, because the other layers prevent grease penetration. As a result, other less expensive grades of paper that don't offer any grease-resistance may be utilized. In accordance with embodiments of the present invention, a paper layer 35 can be selected having a sufficient thickness that advantageously contributes to the bending stiffness and stability of the bag 15 without having to address concerns of grease-resistance which are duly addressed by the polyester film 33. Paper bags 18 are also more difficult to attach zippers and handles thereto.

The adhesive abuttingly adhering the paper layer 35 to the grease-resistant film 33, for example, can be is preferably a tie layer 37, but can alternatively be a solvent-based adhesive. The tie layer 37 can advantageously include an element 17 of polyurethane to better adhere the paper layer 35 to the polyester film 33, if desired.

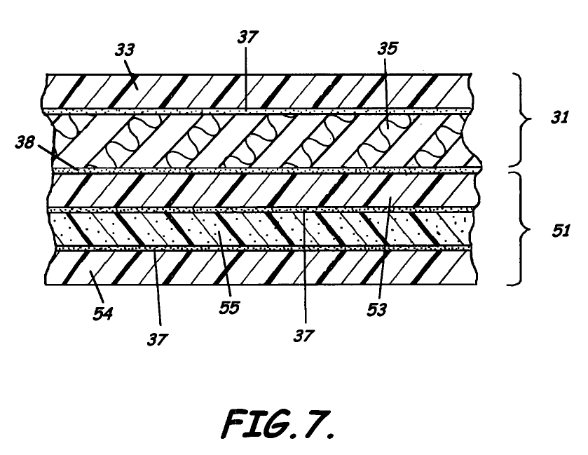

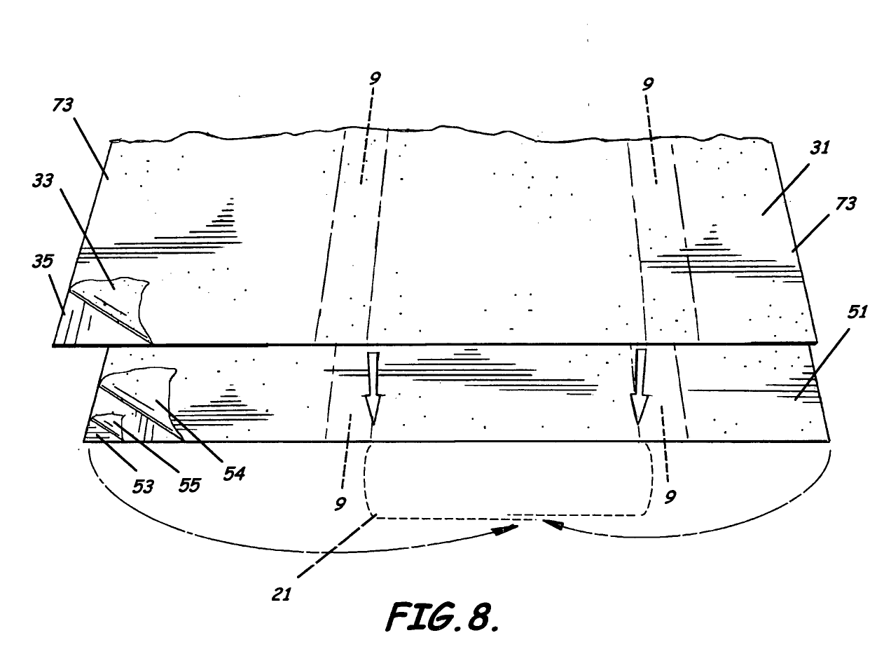

An embodiment of the inner ply 51, shown for example in FIGS. 4-5, includes a multi-layer film laminate having a more grease-resistant material 55 positioned between a pair of heat-sealable films 53, 54. More specifically, for example, an inner face of a first heat-sealable film 53 is abuttingly adhered to an outer face of a grease-resistant material 55 and an inner face of the grease-resistant material 55 is abuttingly adhered to an outer face of a second heat-sealable film 54. The heat-sealable films 53, 54 are adapted to advantageously melt and closingly seal at least one of the bag ends 23, 25 responsive to heat being applied thereto, as understood by those skilled in the art. The inner ply 51 as a whole preferably has a thickness of, for example, in the range of about 1.5 mm to about 3.5 mm, but alternatively can have other varying measures of thickness or gauge. The inner ply 51 is preferably a co-extruded multi-layer structure, but can also be any suitable laminate structure or a mono-layer film.

Embodiments of the first and second heat-sealable films 53, 54 of the inner ply 51 include a material, for example, selected from the group consisting of: polyethylene (PE) and oriented polypropylene (OPP). These heat-sealable films 53, 54, for example, are advantageously capable of melting and bonding together to form a sealable closure in various applications. Embodiments of the grease-resistant material 55 of the inner ply 51 include a material selected from the group consisting of: nylon and polypropylene. Other grease-resistant materials 55 can alternatively be utilized, such as for example, metalized films, ethylene vinyl alcohol, polyester, or other specialty resins. These grease-resistant materials 55, for example, are advantageously capable of resisting and preventing penetration or absorption of grease, mineral oils, solvents, and acids. The first and second heat-sealable films 53, 54 are adhered to the grease-resistant material 55 of the inner ply 51, for example, by tie layers 57 of chemical bond. One embodiment of the tie layers 57 that can be utilized in securing the grease-resistant material 55 between the heat-sealable films 53, 54 is solvent-based petroleum distolate. Alternatively, other suitable adhesives can be utilized as the tie layers 57 as understood by those skilled in the art.

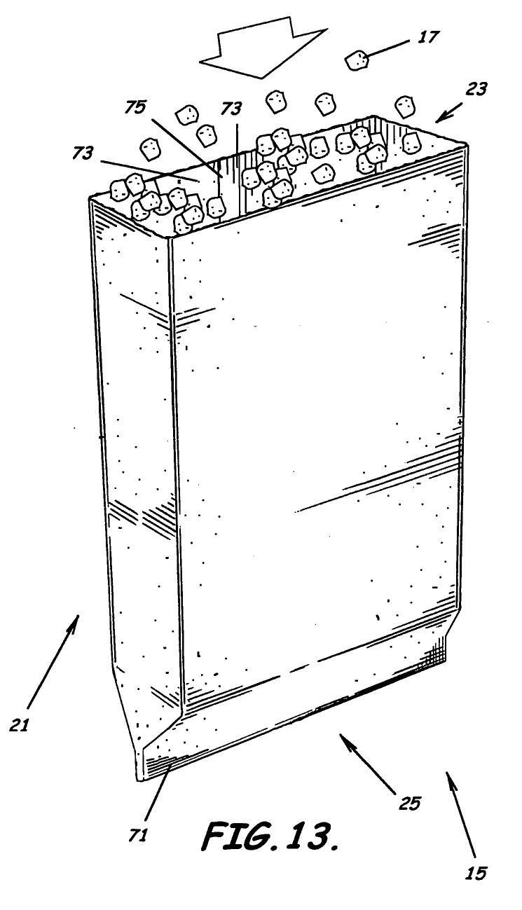

After the inner face of the outer ply 31 is abuttingly adhered to the outer face of the inner ply 51 with an adhesive 38, as shown in FIGS. 6-8, the lateral sides 73 of the bag 15 are joined and overlapped so that the bag 15 illustrates a tubular bag body 21 having a pair of opposing open bag ends 23, 25 as shown in FIG. 9. In one embodiment, a portion of the second heat-sealable film 54 overlies a portion of the polyester film 33 to advantageously define an overlapping seam 75 of the tubular bag body 21 extending along a longitudinal extent of the bag 15. The outer ply 31 has a substantially similar longitudinal length from one bag end 23, 25 to the other bag end 23, 25 along a circumferential periphery of each of the opposing bag ends 23, 25. Also, for example, the inner ply 51 has a substantially similar longitudinal length from one bag end 23, 25 to the other bag end 23, 25 along a circumferential periphery of each of the opposing bag ends 23, 25.

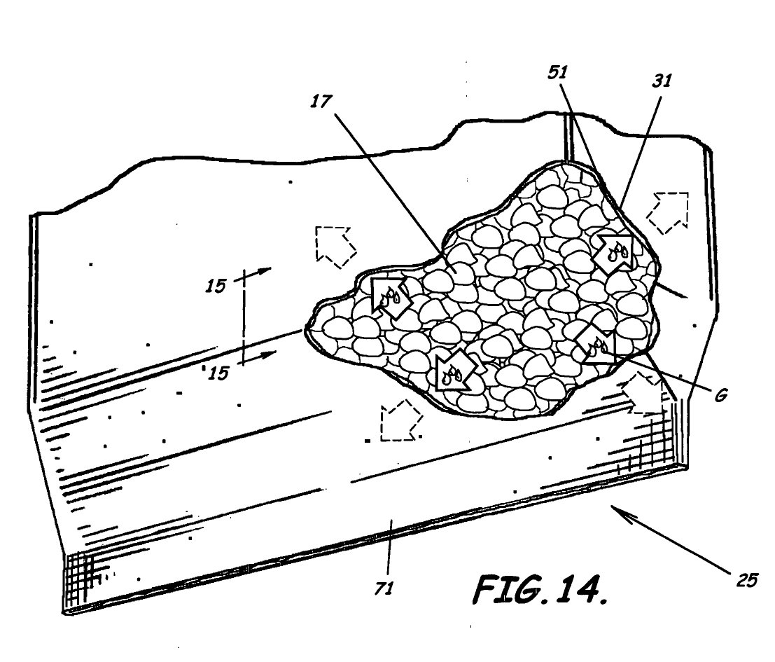

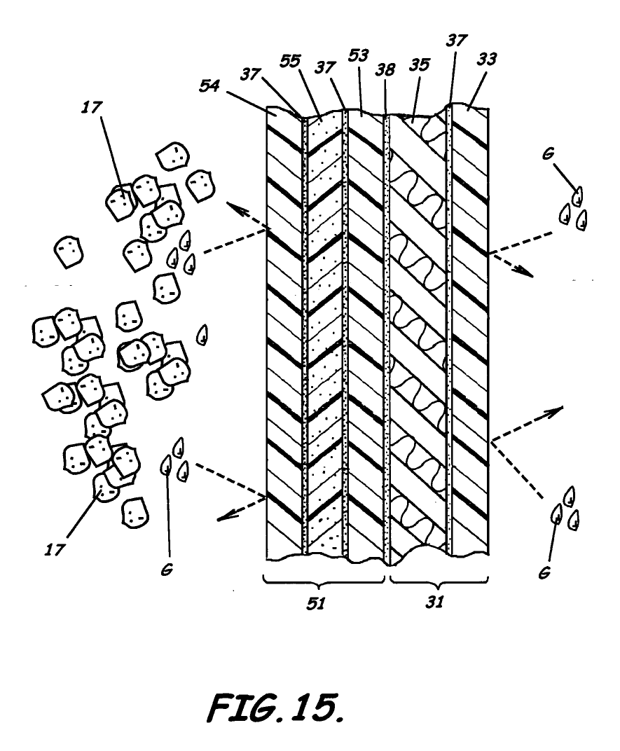

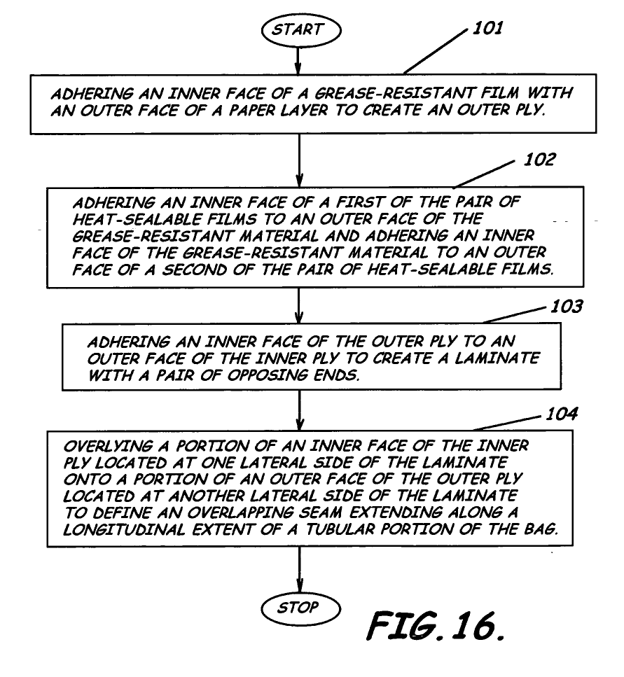

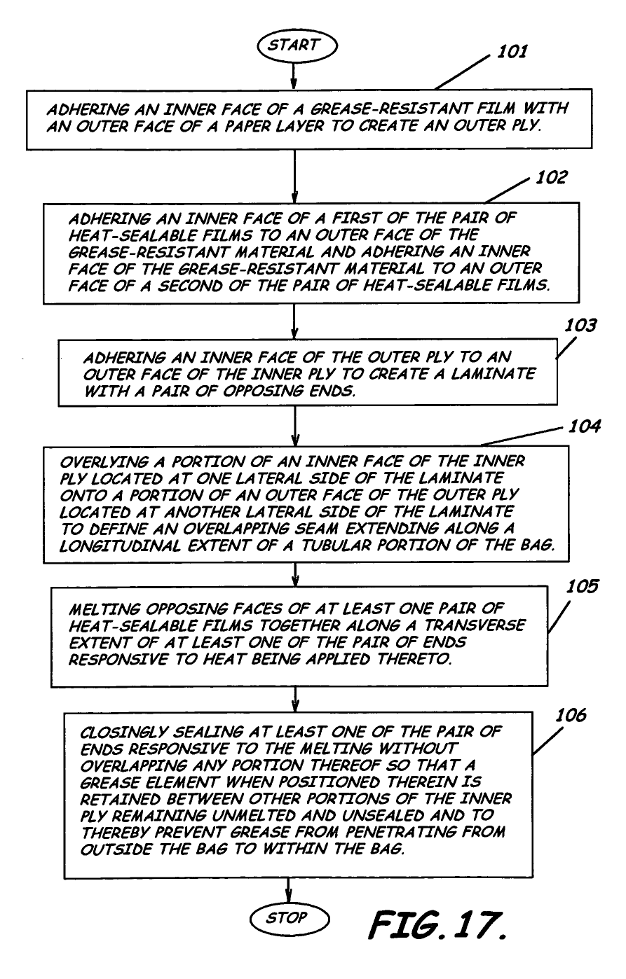

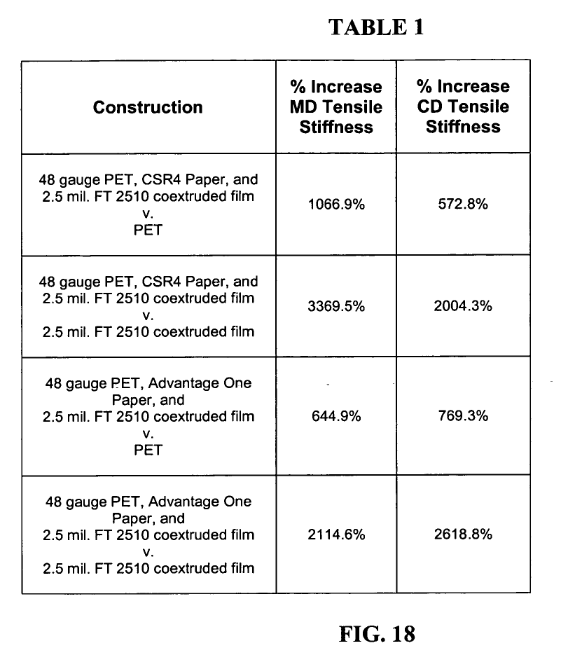

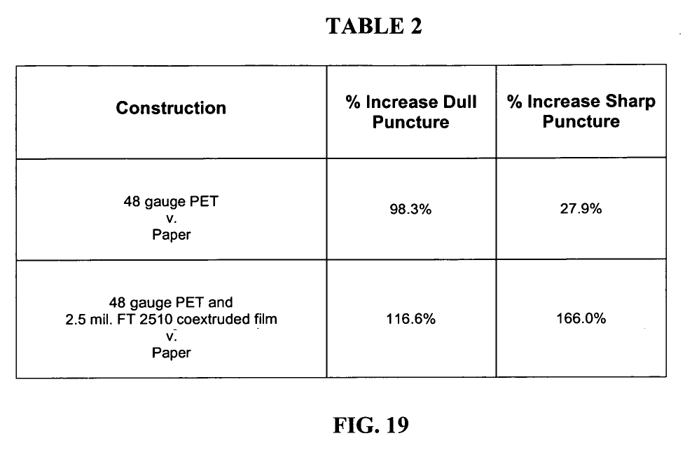

As shown in FIGS. 10-12, each of the pair of bag ends 23, 25 is adapted to be positioned so that opposingly facing first and second portions of the inner ply 51 are compressed between opposingly facing first and second portions of the outer ply 31 to define a compressed lip 71. The compressed lip 71, for example, can have a first portion of the second heat-sealable film 54 of the inner ply 51 meltingly bonded with an opposingly facing second portion of the second heat-sealable film 54 of the inner ply 51 along a transverse extent of at least one of the pair of bag ends 23, 25 responsive to heat applied thereto. Application of the heat to the bag end 23, 25 thereby advantageously closingly seals at least one of the pair of bag ends 23, 25 so that the food element 17, when positioned therein, is retained within inner confines of the bag 15 defined by other unsealed portions of the second heat-sealable film 54 positioned between the opposing bag ends 23, 25. FIGS. 13-15 show the food element 17 positioned inside the bag, illustrating the grease component G being prevented from penetrating the inner and outer plies 51, 31 of the food bag 15.

Each of the materials used to construct the bag 15 can have a different range of melting temperatures. The polyester film 33 of the outer ply 31, for example, has a melting point temperature greater than the heat-sealable film 53 of the inner ply 51. In one embodiment, the polyester film 33 of the outer ply 31 has a melting temperature in the range of about 300 degrees Fahrenheit to about 475 degrees Fahrenheit, and preferably greater than 425 degrees Fahrenheit. In one embodiment, the heat-sealable film 53 of the inner ply 51 has a melting point temperature in the range of about 220 degrees Fahrenheit to about 300 degrees Fahrenheit, and preferably greater than 240 degrees Fahrenheit. As understood by those skilled in the art, the polyethylene heat-sealable film 53 of the inner ply 51 has a lower melting temperature and therefore melts easier and at lower temperatures than the grease-resistant polyester film 33 of the outer ply 31. A sufficiently low melting point temperature for the heat-sealable film 53 of the inner ply 51 advantageously allows for the melting and bonding of the second heat-sealable film 54 to closingly seal the bag end 23, 25, as understood by those skilled in the art.

A heat-sealing bag machine performs the function of forming and shaping the multi-layered structure into a bag 15 by accordingly compressing and melting the bag ends 23, 25 to closingly seal the bag ends 23, 25. The heat-sealing bag machine has an extended heater belt and/or heated jaws that carry out the heat-sealing procedure. The heat can alternatively be applied, for example, by heated rollers, a heated wire/wires, or a heated air zone that adequately melts the heat-sealable film 53, as understood by those skilled in the art. The extended heater belt and/or heated jaws can mass-produce the heat-sealed products through a continuous high-speed operation, which manufactures a quality product in massive quantities to be delivered to customers in the ordinary course of business, as shown for example in FIG. 10. The bag manufacturer typically heat-seals one end of each bag and delivers the bag to a customer, wherefore the customer fills the bag with the proper elements and ultimately heat-seals the other end of the bag. The heat-sealing process can form bags with a lip as herein described, or can alternatively form bags that have a flattened top end and flattened bottom end to thereby provide the capability of stacking multiple bags neatly on top of one another.

To describe the heat-sealing process more specifically, for example, the polyethylene portion of the heat-sealable film 53 of the inner ply 51 at the bag ends 23, 25 is heated to a melting point temperature of at least 220 degrees Fahrenheit, in one embodiment for example, to melt the heat-sealable polyethylene film of the bag ends 23, 25. Alternatively, the temperature could be raised in excess of 300 degrees Fahrenheit, in one embodiment for example, to melt not only portions of the polyethylene heat-sealable films 53 together but also to melt portions of the polyester films 33 together as well, thus advantageously forming an even tighter closed seal at the bag ends 23, 25. In one embodiment, for example, the manufacturer utilizing the heat-sealing bag machine will seal only one end 23, 25 portion of the bag 15, thereby leaving another end 23, 25 portion of the bag 15 open to eventually fill the bag 15 with food or other elements 19. The distributor of the goods, for example, then fills the bag 15 with the food or other elements 19, and thereafter seals the other end 23, 25 portion of the bag 15 after the bag 15 is full.

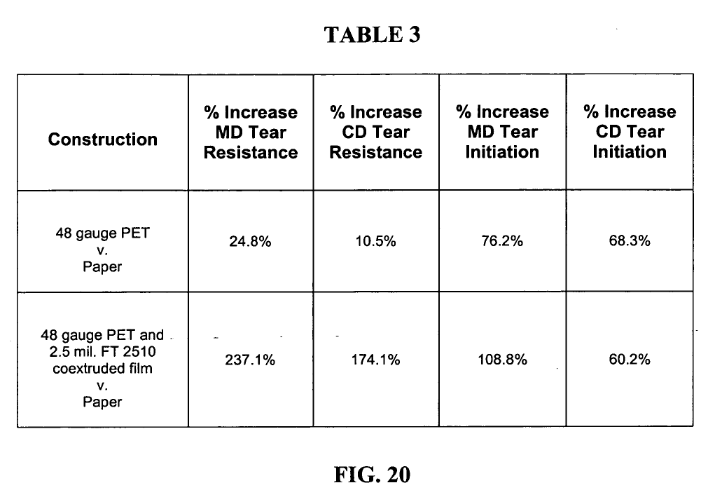

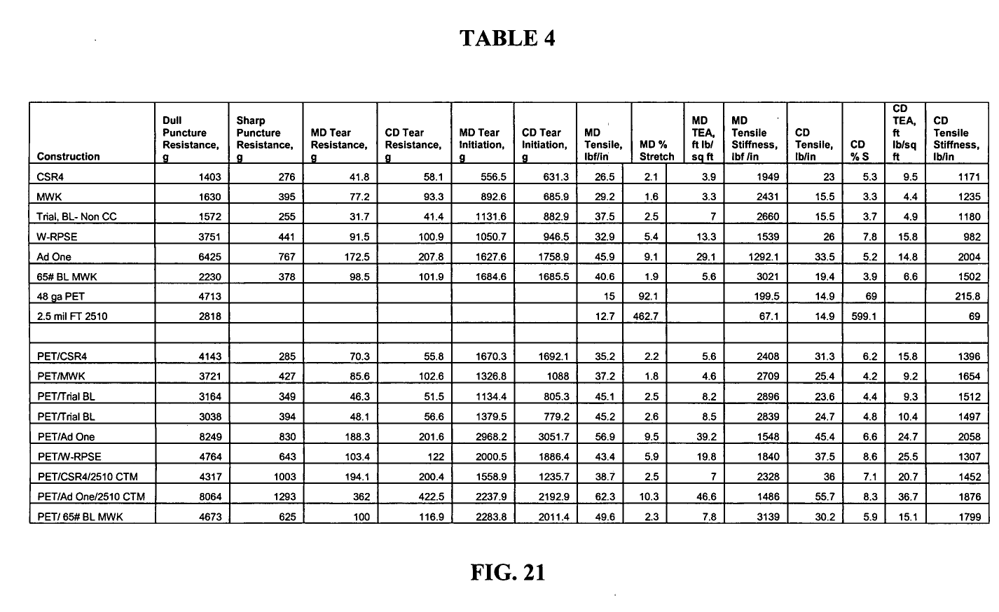

As illustrated in FIGS. 1-17, and as described above herein, the present invention also includes embodiments of methods of assembling, positioning, using, and constructing a multi-layered bag 15. Initially, for example, before any of the layers are bonded or adhered together, the method of constructing a bag 15 can include printing printed indicia 29 on the inner face of the grease-resistant film 33 of the outer ply 31 to advantageously enhance visual appearance of the bag 15. Also, before adhering the layers of film, the method can include clay-coating and bleaching the paper layer 35, and treating the paper layer 35 with a chemical to advantageously provide enhanced protection from grease penetrating through the paper layer 35 of the bag 15.

Embodiments of the method of the present invention of constructing a bag 15, for example, can include adhering an inner face of a grease-resistant film 33 with an outer face of a paper layer 35 to create an outer ply 31. The method can include applying a tie layer 37 between the inner face of the grease-resistant film 33 of the outer ply 31 and the outer face of the paper layer 35 to adhere the grease resistant-film to the paper layer 35. The method can also include adhering a grease-resistant material 55 between a pair of heat-sealable films 53, 54 to create a multi-layer inner ply 51 by advantageously adhering an inner face of a first of the pair of the pair of heat-sealable films 53, 54 to an outer face of the grease-resistant material 55 and adhering an inner face of the grease-resistant material 55 to an outer face of a second of the pair of heat-sealable films 53, 54, and applying tie layers 57 of solvent-based petroleum distolate between the grease-resistant material 55 of the inner ply 51 and the pair of heat-sealable films 53, 54 to adhere the grease-resistant film 33 between the pair of heat-sealable films 53, 54.

Embodiments of methods of the present invention further include adhering an inner face of the outer ply 31 to an outer face of the inner ply 51 to create a laminate with a pair of opposing ends 23, 25. Also, for example, the method can include coating 27 the outer face of the grease-resistant film 33 of the outer ply 31 to provide enhanced protection from grease penetrating from outside the bag 15 to within the bag 15. The method can further include cutting each of the pair of opposing ends 23, 25 so that the outer ply 31 has a substantially similar longitudinal length from one bag end 23, 25 to the other bag end 23, 25 along a circumferential periphery of each of the pair of opposing bag ends 23, 25 and the inner ply 51 has a substantially similar longitudinal length from one bag end 23, 25 to the other bag end 23, 25 along the circumferential periphery of each of the pair of opposing bag ends 23, 25, and overlying a portion of an inner face of the inner ply 51 located at one lateral side 73 of the laminate onto a portion of an outer face of the outer ply 31 located at another lateral side 73 of the laminate to advantageously define an overlapping seam 75 extending along a longitudinal extent of a tubular portion of the bag 15, as understood by those skilled in the art.

Embodiments of the method of the present invention can further include melting opposing faces of at least one of the pair of heat-sealable films 53, 54 together along a transverse extent of at least one of the pair of ends 23, 25 responsive to heat being applied thereto, and compressing opposingly facing first and second portions of the inner ply 51 between opposingly facing first and second portions of the outer ply 31 at a location of at least one of the pair of ends 23, 25 along a transverse extent to thereby define a compressed lip 71, and closingly sealing at least one of the pair of ends 23, 25 responsive to the melting without overlapping any portion thereof so that a grease element 17 when positioned therein is advantageously retained between other portions of the inner ply 51 remaining unmelted and unsealed and to thereby prevent grease from penetrating from within the bag 15 to outside the bag 15 and prevent grease from penetrating from outside the bag 15 to within the bag 15, as understood by those skilled in the art.

Embodiments of the bags and methods of the present invention have important benefits and advantages. The combined use of polymeric structures and paper, for example, combines the advantages of the thickness and bending stiffness of paper with the puncture-resistant and grease-resistant properties of polyester, including the heat-sealable characteristics of films such as polyethylene. Embodiments of the bag provide increased barrier protections from grease, endurance, strength, physical integrity, and heat-sealable characteristics not offered with other bags 18. The bag 15 advantageously prevents problems customarily associated with greasy products such as pet food, for example, and eliminates the absorption and penetrable effect of the grease component included in such foods as pet food. Various bags 18 are often used in other settings where greasy elements 19 are contained within the bags 18, and embodiments of the bag advantageously contribute to solving such problematic concerns attributable to the grease. Other applications of the bag 15 may include dry foods, beverages, feed, soil, lawn and garden, building materials, and other markets to advantageously prevent grease from penetrating from outside the bag 15 to within the bag 15 and to prevent grease from penetrating from within the bag 15 to outside the bag 15. Furthermore, embodiments of the invention offer enhanced strength to allow the bag to carry over twenty-five pounds of pet food with relative ease.

Embodiments of the bags and methods of the present invention offer the further advantage of heat-sealing the bag ends 23, 25 instead of sealing the bag ends 23, 25, for example, as a pinch-bottom structure. The heat-seal offers many advantages over the pinch-bottom structure, including a more secure seal, a tighter bond, a more sound structure, and a more attractive appearance to consumers. The heat-seal advantageously offers more efficient and economical means of manufacturing the bag 15. Further, insect infestation has been a substantial problem associated with pinch-bottom style bags 18. The heat-seal closure of the bag ends 23, 25 solves the problem of insect infestation which has been so prevalent with the pinch-bottom variety of bags 18.

Generally, as understood by those skilled in the art, bags 18 made exclusively from paper are generally not very grease-resistant, nor are paper bags 18 heat-sealable. Bags 18 made exclusively from polyester are generally not stiff enough for optimum bag 15 performance and appearance, as the food elements tend to stretch the polyester bag under pressure and ultimately leave dimples on the exclusively polyester bag. Therefore, the combination of a grease-resistant polyester layer, a paper layer 35, and a heat-sealable layer offer extraordinary advances in the art. A further advantage of the present invention is the environmentally friendly composition of the structure of the present invention by producing bags 18 that are less toxic and increasingly biodegradable, while maintaining inexpensive costs relative to other types of potentially environmentally friendly bags 18. Further, the bag 15 can advantageously be manufactured on existing equipment previously utilized for manufacturing bags 18, so there is no necessity to invest in new and expensive bag 15 manufacturing equipment.

Embodiments of the invention can have many alternative bag styles in addition to the embodiments described, such as for example bag styles of a gusseted pinch-bottom bag, a pinch-bottom bag not gusseted, other various pinch-bottom styles of bags, and block-bottom bags of various constructs. Such features are interchangeable, as understood by those skilled in the art, and are determined by the requirements of the marketplace.

In the drawings and specification, there have been disclosed embodiments of the present invention, and although specific terms are employed, the terms are used in a descriptive sense only and not for purposes of limitation, the scope of the invention being set forth in the following claims. The invention has been described in considerable detail with specific reference to the illustrated embodiments. It will be apparent, however, that various modifications and changes can be made within the spirit and scope of the invention as described in the foregoing specification.

That claimed is:

1. A food bag to carry a food element having a grease component so that grease from the grease component is prevented from penetrating from within the bag to outside the bag and also grease from other grease components not associated with the food bag is prevented from penetrating from outside the bag to within the bag, the food bag comprising:
a tubular bag body having pair of opposing open bag ends and an inner face of an outer ply abuttingly adhering to an outer face of an inner ply, the outer ply including an inner face of a grease-resistant polyester film abuttingly adhered to an outer face of a paper layer with a solventless adhesive, the paper layer having a greater thickness and bending stiffness than the polyester film, the inner face of the polyester film having printed indicia thereon to enhance visual appearance of the bag, the polyester film adapted to allow an amount of light to transmit therethrough to thereby allow viewing of the printed indicia from outside of the bag, and the inner ply including an inner face of a first heat-sealable film abuttingly adhered to an outer face of a grease-resistant material and an inner face of the grease-resistant material abuttingly adhered to an outer face of a second heat-sealable film, a portion of the second heat-sealable film overlying a portion of the polyester film to define an overlapping seam of the tubular bag body extending along a longitudinal extent of the bag, the outer ply having a substantially similar longitudinal length from one bag end to the other bag end along a circumferential periphery of each of the opposing bag ends, the inner ply having a substantially similar longitudinal length from one bag end to the other bag end along a circumferential periphery of each of the opposing bag ends, and the pair of bag ends adapted to be positioned so that opposingly facing first and second portions of the inner ply are compressed between opposingly facing first and second portions of the outer ply to define a compressed lip, the compressed lip having a first portion of the second heat-sealable film of the inner ply meltingly bonded with an opposingly facing second portion of the second heat-sealable film of the inner ply along the transverse extent of at least one of the pair of bag ends responsive to heat applied thereto to thereby closingly seal the at least one of the pair of bag ends so that the food element when positioned therein is retained within inner confines of the bag defined by other unsealed portions of the second heat-sealable film positioned between the opposing pair of bag ends.

2. A bag according to claim 1, wherein the polyester film comprises a polymeric material selected from the group consisting of: polyethylene terephthalate (PET), polyethylene terephthalate polyester (PETP), polytrimethylene terephthalate (PTT), polybutylene terephthalate (PBT), wherein the first and second heat-sealable films of the inner ply comprises a material selected from the group consisting of: polyethylene (PE) and oriented polypropylene (OPP), and wherein the grease-resistant film of the inner ply comprises a material selected from the group consisting of: nylon and polypropylene.

3. A bag according to claim 1, wherein the polyester film is treated with a coating on the outer face of the outer ply to provide an enhanced coefficient of friction in a range of about 0.5 to about 0.9.

4. A bag according to claim 1, wherein the paper layer is clay coated and bleached, and wherein the paper layer is treated with a chemical to provide enhanced protection from grease penetrating through the paper layer of the bag.

5. A bag according to claim 1, wherein the outer face of the polyester film has a coefficient of friction in a range of about 0.5 to about 0.9, and wherein the paper layer has a greater thickness than the polyester film to thereby enhance bending stiffness and increase stabilization of the bag.

6. A bag according to claim 1, wherein the paper layer has a thickness in the range of about 3.5 millimeters to about 4.5 millimeters, and wherein the polyester film has a thickness in the range of about 0.475 millimeters to about 0.485 millimeters, and wherein the polyester film and the paper layer in combination have a percentage increase in tensile stiffness at least 100% greater than the polyester film alone.

7. A bag defined by claim 1, wherein the polyester film and the paper layer in combination have a percentage increase in tensile stiffness at least 750% greater than the polyester film alone.

8. A bag according to claim 1, wherein the solventless adhesive comprises polyurethane, and wherein the first and second heat-sealable films are adhered to the grease-resistant film of the inner ply by a solvent-based petroleum distolate.

9. A bag according to claim 1, wherein the polyester film of the outer ply has a melting point temperature greater than the heat-sealable film of the inner ply, and wherein the polyester film of the outer ply has a melting point temperature in the range of about 300 degrees Fahrenheit to about 475 degrees Fahrenheit and the heat-sealable film of the inner ply has a melting point temperature in the range of about 220 degrees Fahrenheit to about 300 degrees Fahrenheit.

10. A bag comprising:
a bag body having pair of opposing bag ends and an inner face of an outer ply abuttingly adhered to an outer face of an inner ply, the outer ply including an inner face of a grease-resistant film abuttingly adhered to an outer face of a paper layer, and the inner ply including a multi-layer film having a grease-resistant material positioned between a pair of heat-sealable films adapted to melt and closingly seal at least one of the bag ends responsive to heat being applied thereto.

11. A bag according to claim 10, wherein the inner face of the grease-resistant film of the outer ply has printed indicia thereon to enhance visual appearance of the bag, and wherein the grease-resistant film of the outer ply allows an amount of light to transmit therethrough to thereby viewing of the printed indicia from outside of the bag.

12. A bag according to claim 10, wherein the grease-resistant film of the outer ply comprises a polymeric material selected from the group consisting of: polyethylene terephthalate (PET), polyethylene terephthalate polyester (PETP), polytrimethylene terephthalate (PTT), polybutylene terephthalate (PBT), wherein the pair of heat-sealable films of the inner ply comprises a material selected from the group consisting of: polyethylene (PE) and oriented polypropylene (OPP), and wherein the grease-resistant film of the inner ply comprises a material selected from the group consisting of: nylon and polypropylene.

13. A bag according to claim 10, wherein the outer face of the grease-resistant film of the outer ply is treated with a coating to provide an enhanced coefficient of friction in the range of about 0.5 to about 0.9, wherein the paper layer has a greater thickness than the polyester film to thereby enhance bending stiffness and increase stabilization of the bag.

14. A bag according to claim 10, wherein the paper layer has a thickness in the range of about 3.5 millimeters to about 4.5 millimeters, and wherein the grease-resistant film has a thickness in the range of about 0.475 millimeters to about 0.485 millimeters, and wherein the grease-resistant film and the paper layer in combination have a percentage increase in tensile stiffness at least 100% greater than the grease-resistant film alone.

15. A bag defined by claim 10, wherein the grease-resistant film and the paper layer in combination have a percentage increase in tensile stiffness at least 750% greater than the grease-resistant film alone.

16. A bag according to claim 10, wherein the paper layer is clay coated and bleached, and wherein the paper layer is treated with a chemical to provide enhanced protection from grease penetrating through the paper layer of the bag.

17. A bag according to claim 10, wherein the grease-resistant film of the outer ply is adhered to the paper layer by a solventless polyurethane, and wherein the pair of heat-sealable films are adhered to the grease-resistant film of the inner ply by a solvent-based petroleum distolate.

18. A bag according to claim 10, wherein an inner face of a first of the pair of heat-sealable films is abuttingly adhered to an outer face of the grease-resistant material and an inner face of the grease-resistant material is abuttingly adhered to an outer face of a second of the pair of heat-sealable films, and wherein a portion of the second heat-sealable film overlies a portion of the grease-resistant film of the outer ply to define a tubular structure including an overlapping seam of the bag body extending along a longitudinal extent of the bag.

19. A bag according to claim 18, wherein the outer ply has a substantially similar longitudinal length from one bag end to the other bag end along circumferential periphery of each of the pair of opposing bag ends, the inner ply has a substantially similar longitudinal length from one bag end to the other bag end along circumferential periphery of each of the pair of opposing bag ends, and the pair of bag ends are adapted to be positioned so that each of the bag ends are adapted to be positioned so that opposingly facing first and second portions of the inner ply are compressed between opposingly facing first and second portions of the outer ply to define a compressed lip, the compressed lip having a first portion of the second heat-sealable film of the inner ply meltingly bonded to an opposingly facing second portion of the second heat-sealable film of the inner ply along the transverse extent of at least one of the pair of bag ends responsive to heat applied thereto to thereby closingly seal the at least one of the pair of bag ends so that a grease element when positioned therein is retained within inner confines of the bag defined by other unsealed portions of the second heat-sealable film positioned between the opposing pair of bag ends.

20. A bag according to claim 10, wherein the grease-resistant film of the outer ply has a melting point temperature greater than the heat-sealable film of the inner ply, and wherein the grease-resistant film of the outer ply has a melting point temperature in the range of about 300 degrees Fahrenheit to about 475 degrees Fahrenheit and the heat-sealable film of the inner ply has a melting point temperature 220 degrees Fahrenheit to about 300 degrees Fahrenheit.

21. A method of constructing a bag, the method comprising:
(a) adhering an inner face of a grease-resistant film with an outer face of a paper layer to create an outer ply;
(b) adhering a grease-resistant material between a pair of heat-sealable films to create a multi-layer inner ply;
(c) adhering an inner face of the outer ply to an outer face of the inner ply to create a laminate with a pair of opposing ends; and
(d) overlying a portion of an inner face of the inner ply located at one lateral side of the laminate onto a portion of an outer face of the outer ply located at another lateral side of the laminate to define an overlapping seam extending along a longitudinal extent of a tubular portion of the bag.

22. A method according to claim 21, wherein step (b) comprises adhering an inner face of a first of the pair of the pair of heat-sealable films to an outer face of the grease-resistant material and adhering an inner face of the grease-resistant material to an outer face of a second of the pair of heat-sealable films.

23. A method according to claim 21, further comprising:
(e) melting opposing faces of at least one of the pair of heat-sealable films together along a transverse extent of at least one of the pair of ends responsive to heat being applied thereto; and
(f) closingly sealing at least one of the pair of ends responsive to the melting without overlapping any portion thereof so that a grease element when positioned therein is retained between other portions of the inner ply remaining unmelted and unsealed and to thereby prevent grease from penetrating from within the bag to outside the bag and prevent grease from penetrating from outside the bag to within the bag.

24. A method according to claim 21, further comprising before step (a) printing printed indicia on the inner face of the grease-resistant film of the outer ply to enhance visual appearance of the bag, and before step (d) coating the outer face of the grease-resistant film of the outer ply provide an enhanced coefficient of friction of the bag.

25. A method according to claim 21, wherein the grease-resistant film of the outer ply comprises a polymeric material selected from the group consisting of: polyethylene terephthalate (PET), polyethylene terephthalate polyester (PETP), polytrimethylene terephthalate (PTT), polybutylene terephthalate (PBT), wherein the pair of heat-sealable films of the inner ply comprises a material selected from the group consisting of: polyethylene (PE) and oriented polypropylene (OPP), and wherein the grease-resistant film of the inner ply comprises a material selected from the group consisting of: nylon and polypropylene.

26. A method according to claim 21, wherein step (a) further comprises applying a solventless polyurethane adhesive between the inner face of the grease-resistant film of the outer ply and the outer face of the paper layer to adhere the grease resistant-film to the paper layer, wherein step (b) further comprises applying a solvent-based petroleum distolate between the grease-resistant material of the inner ply and the pair of heat-sealable films to adhere the grease-resistant film between the pair of heat-sealable films, and further comprising before step (a) clay-coating and bleaching the paper layer, and treating the paper with a chemical to provide enhanced protection from grease penetrating through the paper layer of the bag.

27. A method according to claim 21, further comprising before step (d) cutting each of the pair of opposing ends so that the outer ply has a substantially similar longitudinal length from one bag end to the other bag end along a circumferential periphery of each of the pair of opposing bag ends and the inner ply has a substantially similar longitudinal length from one bag end to the other bag end along the circumferential periphery of each of the pair of opposing bag ends.

28. A method according to claim 21, wherein step (e) further comprises compressing opposingly facing first and second portions of the inner ply between opposingly facing first and second portions of the outer ply at a location of at least one of the pair of ends along a transverse extent to thereby define a compressed lip.
